(19) United States
(12) Patent Application Publication
(10) Pub. No.: US 2025/0373543 A1
(43) Pub. Date: Dec. 4, 2025

(54) SR-TE PATH FRR ADDITION

(71) Applicant: HUAWEI TECHNOLOGIES CO., LTD., Shenzhen (CN)

(72) Inventor: Huaimo Chen, Bolton, MA (US)

(21) Appl. No.: 19/305,117

(22) Filed: Aug. 20, 2025

Related U.S. Application Data
(63) Continuation of application No. PCT/US2024/012679, filed on Jan. 24, 2024.
(60) Provisional application No. 63/486,005, filed on Feb. 20, 2023.

(51) Int. Cl. H04L 45/28; H04L 45/12; H04L 45/122

(52) U.S. Cl. CPC H04L 45/28; H04L 45/122; H04L 45/123

(57) ABSTRACT

A method comprises receiving a packet, where the packet comprises a binding SID (BSID) of a node and a first list of segment identifiers (SIDs) of a Segment Routing Traffic Engineering (SR-TE) path that includes a first node SID of a non-neighbor upstream endpoint node of the node and a second node SID of the node, the BSID is associated with a second list of SIDs; determining that the second node SID is a failed node SID of the node; removing, in response to the determining, the first node SID and the second node SID from the packet; replacing the BSID in the packet with the second list; and sending the packet to a next hop node on an interior gateway protocol (IGP) shortest path to a destination node after the IGP has converged.

### CROSS-REFERENCE TO RELATED APPLICATIONS

This patent application is a continuation of International Patent Application No. PCT/US2024/012679 filed on Jan. 24, 2024, by Futurewei Technologies, Inc., and titled “SR-TE Path FRR Addition,” which claims the benefit of U.S. Provisional Patent Application No. 63/486,005 filed on Feb. 20, 2023 by Futurewei Technologies, Inc., and titled “SR-TE Path FRR Addition,” which are hereby incorporated by reference.

### TECHNICAL FIELD

The present application relates to network communication, and more specifically to extending the fast re-route (FRR) protection for the failure of a transit node of a segment routing traffic engineering (SR-TE) multiprotocol label switching (MPLS) path after the interior gateway protocol (IGP) converges.

### BACKGROUND

MPLS is a routing technique in telecommunications networks that directs data from one node to the next based on labels rather than network addresses. Whereas network addresses identify endpoints, the labels identify established paths between endpoints. MPLS can encapsulate packets of various network protocols, hence the multiprotocol component of the name.

An interior gateway protocol (IGP) or interior routing protocol is a type of routing protocol used for exchanging routing table or link state information between gateways (commonly routers) within an autonomous system (for example, a system of corporate local area networks). This routing information can then be used to route network-layer protocols like Internet Protocol (IP) packets.

### SUMMARY

The present disclosure describes various embodiments to extend the fast re-route protection for the failure of a transit node of an SR-TE MPLS path after the IGP converges on the failure. The disclosed embodiments allow traffic to continue to be forwarded on the SR-TE path after the failure of a node used in the path's segment list and protect the node segment identifier (SID), adjacency SID, and binding SID of the failed node on the path. The present disclosure further describes extensions to path computation element protocol (PCEP) for distributing binding protection information to an upstream neighbor node or the closest upstream endpoint node of the node on the SR-TE path that may protect the binding SID of the node. The disclosed embodiments are simple, provide more coverage, and improve network reliability relative to the existing solutions. The disclosed embodiments can be deployed in any router, switch, and controller, which are used by service providers around the world.

A first aspect relates to a method for enabling traffic to continue to be forwarded on a Segment Routing Traffic Engineering (SR-TE) path after a failure of a node along the SR-TE path, the method comprising: receiving, by a non-neighbor upstream endpoint node of the node along the SR-TE path, a packet, wherein the packet comprises a list of segment identifiers (SIDs) of the SR-TE path that includes a first node SID of the non-neighbor upstream endpoint node and a second node SID of the node; determining, by the non-neighbor upstream endpoint node, the second node SID is a failed node SID of the node along the SR-TE path; removing, by the non-neighbor upstream endpoint node in response to determining that the second node SID is the failed node SID of the node, the first node SID and the second node SID from the packet; and sending, by the non-neighbor upstream endpoint node, the packet to a next hop node on an interior gateway protocol (IGP) shortest path to a destination node after the IGP has converged.

Optionally, in any of the preceding aspects, another implementation of the aspect further comprising sending the packet towards a node Nx along the IGP shortest path to the node Nx when a top SID of the packet is a node SID of the node Nx, wherein Nx is a next hop node of the failed node along the SR-TE path.

Optionally, in any of the preceding aspects, another implementation of the aspect further comprising when a top SID of the packet is an adjacency SID of the node, obtaining, by the non-neighbor upstream endpoint node, a remote node of the adjacency from the adjacency SID; replacing, by the non-neighbor upstream endpoint node, the adjacency SID with a node SID of the remote node; and sending, by the non-neighbor upstream endpoint node, the packet towards the remote node along the IGP shortest path to the remote node.

Optionally, in any of the preceding aspects, another implementation of the aspect further comprising when a top SID of the packet is a binding SID (BSID) of the node, replacing, by the non-neighbor upstream endpoint node, the BSID in the packet with a second list of SIDs associated with the BSID; and sending, by the non-neighbor upstream endpoint node, the packet to a next hop node towards a destination node along the IGP shortest path to the destination node after the IGP has converged.

Optionally, in any of the preceding aspects, another implementation of the aspect further comprising when a top SID of the packet is a binding SID (BSID) of the node, replacing, by the non-neighbor upstream endpoint node, the BSID in the packet with a second list of SIDs associated with the BSID; and when the top SID is an adjacency SID of the node, obtaining, by the non-neighbor upstream endpoint node, a remote node of the adjacency from the adjacency SID; replacing, by the non-neighbor upstream endpoint node, the adjacency SID with a node SID of the remote node; and sending, by the non-neighbor upstream endpoint node, the packet towards the remote node along the IGP shortest path to the remote node.

A second aspect relates to a method for enabling traffic to continue to be forwarded on a Segment Routing Traffic Engineering (SR-TE) path after a failure of a node along the SR-TE path, the method comprising: receiving, by a non-neighbor upstream endpoint node of the node along the SR-TE path, a packet, wherein the packet comprises a binding SID (BSID) of the node and a first list of segment identifiers (SIDs) of the SR-TE path, and wherein the first list includes a first node SID of the non-neighbor upstream endpoint node and a second node SID of the node, and wherein the BSID is associated with a second list of SIDs; determining, by the non-neighbor upstream endpoint node, that the second node SID is a failed node SID of the node along the SR-TE path; removing, by the non-neighbor upstream endpoint node in response to determining that the second node SID is the failed node SID of the node, the first node SID and the second node SID from the packet; replacing, by the non-neighbor upstream endpoint node, the BSID in the packet with the second list; and sending, by the non-neighbor upstream endpoint node, the packet to a next hop node on an interior gateway protocol (IGP) shortest path to a destination node after the IGP has converged.

Optionally, in any of the preceding aspects, another implementation of the aspect further comprising sending the packet towards a node Nx along the IGP shortest path to the node Nx when a top SID of the packet is a node SID of the node Nx.

Optionally, in any of the preceding aspects, another implementation of the aspect further comprising when a top SID of the packet is an adjacency SID of the node, obtaining, by the non-neighbor upstream endpoint node, a remote node of the adjacency from the adjacency SID; replacing, by the non-neighbor upstream endpoint node, the adjacency SID with a node SID of the remote node; and sending, by the non-neighbor upstream endpoint node, the packet towards the remote node along the IGP shortest path to the remote node.

Optionally, in any of the preceding aspects, another implementation of the aspect further comprising receiving, by the non-neighbor upstream endpoint node, a first message, wherein the non-neighbor upstream endpoint node receives the first message from a path computation element (PCE) controller, wherein the first message comprises binding protection information corresponding to binding information of the node, wherein the binding information includes the BSID and the second list, and wherein the binding protection information includes the BSID, a third list of SIDs corresponding to the second list, an identifier (ID) of the node, and an instruction; and using, by the non-neighbor upstream endpoint node based on the instruction, the binding protection information to protect the BSID of the failed node when the node fails.

Optionally, in any of the preceding aspects, another implementation of the aspect further comprising exchanging a capability of distributing binding protection information and adjacency protection information with the non-neighbor upstream endpoint node in a PATH_SETUP_TYPE_CAPABILITY type length value (TLV) with a Path Setup Type (PST) and a sub-TLV in an Open object of an Open message.

Optionally, in any of the preceding aspects, another implementation of the aspect provides that the sub-TLV comprises a type field, a length field, a reserved field, and a flags field.

Optionally, in any of the preceding aspects, another implementation of the aspect further comprising exchanging a capability of distributing binding protection information and adjacency protection information with the non-neighbor upstream endpoint node using a PCECC-CAPABILITY Sub-TLV comprised in a PATH_SETUP_TYPE_CAPABILITY TLV in an Open message.

Optionally, in any of the preceding aspects, another implementation of the aspect provides that PCECC-CAPABILITY Sub-TLV comprises a B flag field set to a value indicating that a PCEP speaker supports the binding protection information and adjacency protection information distribution.

Optionally, in any of the preceding aspects, another implementation of the aspect provides that the first message is a path computation update request (PCUpd) message.

Optionally, in any of the preceding aspects, another implementation of the aspect provides that the PCUpd message comprises a Request Parameters (RP) object or Stateful Request Parameters (SRP) object, and wherein the RP/SRP object comprises a PATH-SETUP-TYPE TLV with a Path Setup Type (PST), a BSID TLV comprising a BSID of the node, SID-List TLV comprising a list of SIDs, and a node ID TLV comprising the identifier of the node.

Optionally, in any of the preceding aspects, another implementation of the aspect provides that the PCUpd message comprises a Request Parameters (RP) object or Stateful Request Parameters (SRP) object, and wherein the RP/SRP object comprises a PATH-SETUP-TYPE TLV with a Path Setup Type (PST), adjacency SID (ASID) TLV comprising an adjacency SID of a node, a node SID (NSID) TLV comprising a node SID of a remote node of the adjacency indicated by the adjacency SID and a node ID TLV comprising the identifier of the node.

Optionally, in any of the preceding aspects, another implementation of the aspect provides that the identifier comprises an Open Shortest Path First (OSPF) node identifier, an Intermediate System to Intermediate System (IS-IS) Node identifier, or a BGP node identifier.

A third aspect relates to a non-neighbor upstream endpoint node configured to enable traffic to continue to be forwarded on a Segment Routing Traffic Engineering (SR-TE) path after a failure of a node along the SR-TE path, the non-neighbor upstream endpoint node comprising a memory storing instructions; and one or more processors coupled to the memory and configured to execute the instructions to cause the non-neighbor upstream endpoint node to: receive a packet, wherein the packet comprises a list of segment identifiers (SIDs) of the SR-TE path that includes a first node SID of the non-neighbor upstream endpoint node and a second node SID of the node; determine that the second node SID is a failed node SID of the node; remove, in response to determining that the second node SID is the failed node SID of the node, the first node SID and the second node SID from the packet; and send the packet to a next hop node on an interior gateway protocol (IGP) shortest path to a destination node after the IGP has converged.

Optionally, in any of the preceding aspects, another implementation of the aspect provides that the one or more processors are further configured to execute the instructions to cause the non-neighbor upstream endpoint node to send the packet towards a node Nx along the IGP shortest path to the node Nx when a top SID of the packet is a node SID of the node Nx.

Optionally, in any of the preceding aspects, another implementation of the aspect provides that when a top SID of the packet is an adjacency SID of the node, the one or more processors are further configured to execute the instructions to cause the non-neighbor upstream endpoint node to obtain a remote node of the adjacency from the adjacency SID; replace the adjacency SID with a node SID of the remote node; and send the packet towards the remote node along the IGP shortest path to the remote node.

Optionally, in any of the preceding aspects, another implementation of the aspect provides that when a top SID of the packet is a Binding SID (BSID) of the node, the one or more processors are further configured to execute the instructions to cause the non-neighbor upstream endpoint node to: replace the BSID in the packet with a second list of SIDs associated with the BSID; and send the packet to a next hop node towards a destination node along the IGP shortest path to the destination node after the IGP has converged.

Optionally, in any of the preceding aspects, another implementation of the aspect provides that when a top SID of the packet is a Binding SID (BSID) of the node, the one or more processors are further configured to execute the instructions to cause the non-neighbor upstream endpoint node to: replace the BSID in the packet with a second list of SIDs associated with the BSID; and when the top SID is an adjacency SID of the node, obtain a remote node of the adjacency from the adjacency SID; replace the adjacency SID with a node SID of the remote node; and send the packet towards the remote node along the IGP shortest path to the remote node.

A fourth aspect relates to a non-neighbor upstream endpoint node configured to enable traffic to continue to be forwarded on a Segment Routing Traffic Engineering (SR-TE) path after a failure of a node along the SR-TE path, the non-neighbor upstream endpoint node comprising: a memory storing instructions; and one or more processors coupled to the memory and configured to execute the instructions to cause the non-neighbor upstream endpoint node to: receive a packet, wherein the packet comprises a binding SID (BSID) of the node and a first list of segment identifiers (SIDs) of the SR-TE path, and wherein the first list includes a first node SID of the non-neighbor upstream endpoint node and a second node SID of the node, and wherein the BSID is associated with a second list of SIDs; determine that the second node SID is a failed node SID of the node along the SR-TE path; remove, in response to determining that the second node SID is the failed node SID of the node, the first node SID and the second node SID from the packet; replace the BSID in the packet with the second list; and send the packet to a next hop node on an interior gateway protocol (IGP) shortest path to a destination node after the IGP has converged.

Optionally, in any of the preceding aspects, another implementation of the aspect provides that the one or more processors are further configured to execute the instructions to cause the non-neighbor upstream endpoint node to send the packet towards a node Ny along the IGP shortest path to the node Ny when a top SID of the packet is a node SID of the node Ny.

Optionally, in any of the preceding aspects, another implementation of the aspect provides that when a top SID of the packet is an adjacency SID of the node, the one or more processors are further configured to execute the instructions to cause the non-neighbor upstream endpoint node to: obtain a remote node of the adjacency from the adjacency SID; replace the adjacency SID with a node SID of the remote node; and send the packet towards the remote node along the IGP shortest path to the remote node.

Optionally, in any of the preceding aspects, another implementation of the aspect provides that the one or more processors are further configured to execute the instructions to cause the non-neighbor upstream endpoint node to: receive a first message, wherein the non-neighbor upstream endpoint node receives the first message from a path computation element (PCE) controller, wherein the first message comprises binding protection information corresponding to binding information of the node, wherein the binding information includes the BSID and the second list, and wherein the binding protection information includes the BSID, a third list of SIDs corresponding to the second list, an identifier (ID) of the node, and an instruction; and use, based on the instruction, the binding protection information to protect the BSID of the failed node when the node fails.

Optionally, in any of the preceding aspects, another implementation of the aspect provides that the one or more processors are further configured to execute the instructions to cause the non-neighbor upstream endpoint node to exchange a capability of distributing binding protection information and adjacency protection information with the non-neighbor upstream endpoint node in a PATH_SETUP_TYPE_CAPABILITY type length value (TLV) with a Path Setup Type (PST) and a sub-TLV in an Open object of an Open message.

Optionally, in any of the preceding aspects, another implementation of the aspect provides that the sub-TLV comprises a type field, a length field, a reserved field, and a flags field.

Optionally, in any of the preceding aspects, another implementation of the aspect provides that the one or more processors are further configured to execute the instructions to cause the non-neighbor upstream endpoint node to exchange a capability of distributing binding protection information and adjacency protection information with the non-neighbor upstream endpoint node using a PCECC-CAPABILITY Sub-TLV comprised in a PATH_SETUP_TYPE_CAPABILITY TLV in an Open message.

Optionally, in any of the preceding aspects, another implementation of the aspect provides that the PCECC-CAPABILITY Sub-TLV comprises a B flag field set to a value indicating that a PCEP speaker supports the binding protection information and adjacency protection information distribution.

Optionally, in any of the preceding aspects, another implementation of the aspect provides that the first message is a path computation update request (PCUpd) message.

Optionally, in any of the preceding aspects, another implementation of the aspect provides that the PCUpd message comprises a Request Parameters (RP) object or Stateful Request Parameters (SRP) object, and wherein the RP/SRP object comprises a PATH-SETUP-TYPE TLV with a Path Setup Type (PST), a BSID TLV comprising a BSID of the node, SID-List TLV comprising a list of SIDs, and a node ID TLV comprising the identifier of the node.

Optionally, in any of the preceding aspects, another implementation of the aspect provides that the PCUpd message comprises a Request Parameters (RP) object or Stateful Request Parameters (SRP) object, and wherein the RP/SRP object comprises a PATH-SETUP-TYPE TLV with a Path Setup Type (PST), adjacency SID (ASID) TLV comprising an adjacency SID of a node, a node SID (NSID) TLV comprising a node SID of a remote node of the adjacency indicated by the adjacency SID and a node ID TLV comprising the identifier of the node.

Optionally, in any of the preceding aspects, another implementation of the aspect provides that the identifier comprises an Open Shortest Path First (OSPF) node identifier, an Intermediate System to Intermediate System (IS-IS) node identifier, or a BGP node identifier.

A fifth aspect relates to a non-transitory computer readable medium comprising a computer program product for use by a network node, the computer program product comprising computer executable instructions stored on the non-transitory computer readable medium that, when executed by one or more processors, cause the network node to execute the method of any of the first aspect.

A sixth aspect relates to a non-transitory computer readable medium comprising a computer program product for use by a network node, the computer program product comprising computer executable instructions stored on the non-transitory computer readable medium that, when executed by one or more processors, cause the network node to execute the method of any of the second aspect.

A seventh aspect relates to a non-neighbor upstream endpoint node configured to enable traffic to continue to be forwarded on a Segment Routing Traffic Engineering (SR-TE) path after a failure of a node along the SR-TE path, comprising means for performing the method of any of the first aspect.

An eighth aspect relates to a non-neighbor upstream endpoint node configured to enable traffic to continue to be forwarded on a Segment Routing Traffic Engineering (SR-TE) path after a failure of a node along the SR-TE path, comprising means for performing the method of any of the second aspect.

For the purpose of clarity, any one of the foregoing embodiments may be combined with any one or more of the other foregoing embodiments to create a new embodiment within the scope of the present disclosure.

These and other features, and the advantages thereof, will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1A is a schematic diagram illustrating an example network topology of the SR-TE MPLS path in normal operations and before IGP convergence on the failure according to an embodiment of the present disclosure.

FIG. 1B is a schematic diagram illustrating an example network topology of the SR-TE MPLS path after IGP convergence on the failure according to an embodiment of the present disclosure.

FIG. 2A is a schematic diagram illustrating an example network topology of the SR-TE MPLS path with binding SID (BSID) in normal operations and before IGP convergence on the failure according to an embodiment of the present disclosure.

FIG. 2B is a schematic diagram illustrating an example network topology with the SR-TE MPLS path with binding SID (BSID) after IGP convergence on the failure according to an embodiment of the present disclosure.

FIG. 3 is an algorithm used to implement a procedure on a node of an SR-TE MPLS path according to an embodiment of the disclosure.

FIG. 4 is an algorithm used to implement a procedure on a node of an SR-TE MPLS path according to an embodiment of the disclosure.

FIG. 5A is a schematic diagram illustrating a format of a Binding-Adjacency PROTECTION_CAPABILITY (B-A-P) sub-TLV according to an embodiment of the present disclosure.

FIG. 5B is a schematic diagram illustrating a format of a PATH-SETUP-TYPE-CAPABILITY TLV according to an embodiment of the present disclosure.

FIG. 5C is a schematic diagram illustrating a format of a PCECC-CAPABILITY Sub-TLV according to an embodiment of the present disclosure.

FIG. 6 is a schematic diagram illustrating a format of a PATH-SETUP-TYPE TLV according to an embodiment of the present disclosure.

FIG. 7A is a schematic diagram illustrating a format of a BSID TLV according to an embodiment of the present disclosure.

FIG. 7B is a schematic diagram illustrating a format of an adjacency SID (ASID) TLV according to an embodiment of the present disclosure.

FIG. 7C is a schematic diagram illustrating a format of a node SID (NSID) TLV according to an embodiment of the present disclosure.

FIG. 8A is a schematic diagram illustrating a format of SID-list TLV according to an embodiment of the present disclosure.

FIG. 8B is a schematic diagram illustrating a format of TE router ID TLV according to an embodiment of the present disclosure.

FIG. 9 is a flowchart illustrating a method performed by a non-neighbor upstream node for enabling traffic to continue to be forwarded on an SR-TE path after a failure of a node according to an embodiment of the present disclosure.

FIG. 10 is a flowchart illustrating a method performed by a non-neighbor upstream node for enabling traffic to continue to be forwarded on an SR-TE path after a failure of a node according to an embodiment of the present disclosure.

FIG. 11 is a schematic diagram illustrating a network element according to an embodiment of the present disclosure.

### DETAILED DESCRIPTION

It should be understood at the outset that, although illustrative implementations of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Several mechanisms have been proposed that provide fast re-route protection for the failure of a node on an SR-TE MPLS path by a neighbor upstream node as a point of local repair (PLR) of the failed node. An Internet Engineering Task Force (IETF) document entitled “Topology Independent Fast Reroute using Segment Routing” by S. Litkowski, et al., published January 2022 describes an SR FRR mechanism that provides fast re-route protection for the failure of a node on an SR-TE path by a neighbor upstream node as point of local repair (PLR) of the failed node. However, once the IGP converges, the SR FRR is no longer sufficient to forward traffic of the path around the failure, since a non-neighbor upstream endpoint node of the failed node will no longer have a route to the failed node and drop the traffic. Another, IETF document entitled “Segment Protection for SR-TE Paths” by S. Hegde, et al., published March 2022 presents a solution in which a hold-down timer is configured on every node in a network. After the IGP converges on a node failure, when a node is going to delete the route to the failed node, instead of programming a route delete, it programs a tunnel/path to the node consisting of the node segment identifier (SID) of the nearside neighbor of the failed node followed by the original path in the packet. The modified path will be in force until the hold-down timer expires. These existing solutions for fast protection against the failure of the node of an SR-TE MPLS path after IGP converges on the failure are complex and provide poor protection coverage.

The present disclosure describes various embodiments to extend the fast re-route protection for the failure on an SR-TE MPLS path (or simply, SR-TE path or SR-MPLS path) after the IGP converges. The disclosed embodiments allow traffic to continue to be forwarded on an SR-TE path after the failure of a node used in the path's segment list and protect the node SID (NSID), adjacency SID (ASID), and binding SID (BSID) of the failed node on the path. The present disclosure further describes extensions to path computation element protocol (PCEP) for distributing binding protection information to an upstream neighbor node and the closest upstream endpoint node of the node on SR-TE path that may protect the binding SID of the node. The disclosed embodiments are simple, provide more coverage, and improve network reliability relative to the existing solutions. The disclosed embodiments can be deployed in any router, switch, and controller, which are used by service providers around the world.

In an embodiment, the present disclosure illustrates an extension to SR-MPLS FRR for the failure on SR-MPLS paths through examples and the procedure on every related node on each path without any failure and with a failure before and after the IGP converges on the failure.

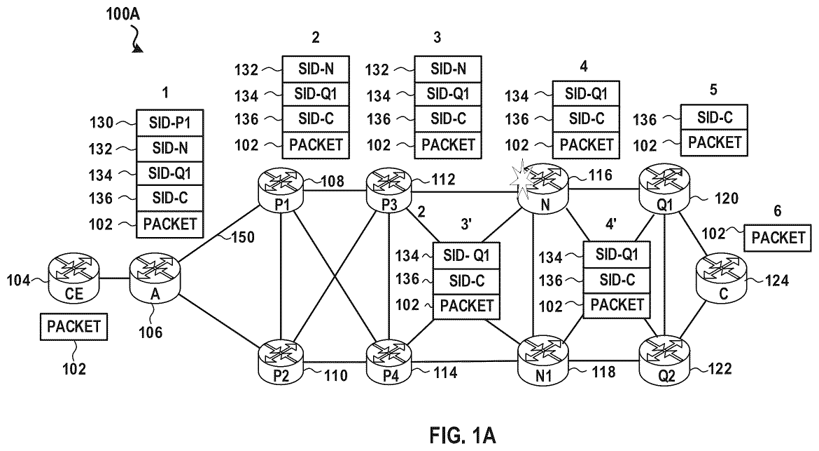

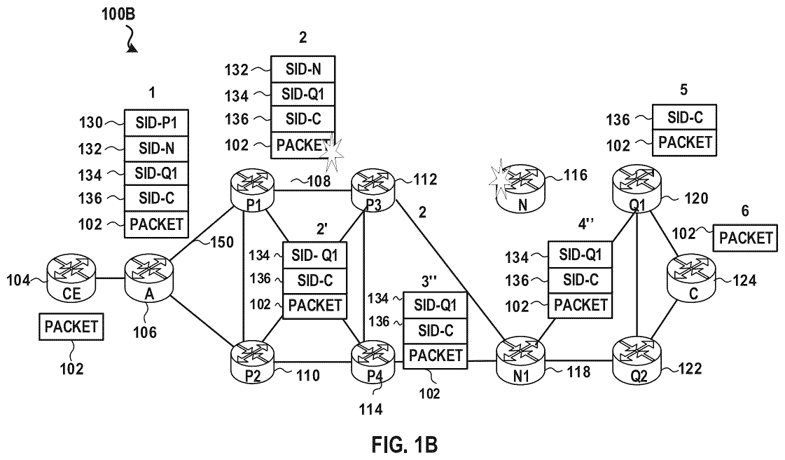

FIG. 1A is a schematic diagram illustrating an example network topology 100A of SR-TE MPLS path in normal operations and before IGP convergence on the failure according to an embodiment of the present disclosure. The network topology 100A receives a packet 102 from a content source (or a customer edge) 104. The content source 104 may be a network node, a server, a data center, or other telecommunications device configured to receive and respond to requests for content. The network topology 100A includes a plurality of network nodes (or simply, nodes) 106, 108, 110, 112, 114, 116, 118, 120, 122, and 124. While ten network nodes 106-124 are shown in the network topology 100A, more or fewer nodes may be included in practical applications.

Each of the network nodes 106-124 may comprise a router, switch, or other telecommunications device configured to receive, route, store, and transmit packets. Some of the network nodes, namely the network nodes 106 and 124 are disposed at an edge of the network topology 100A. The network nodes 106 and 124 receiving packets may be referred to as an ingress network node (or simply, an ingress node) or an upstream hop node. The network nodes 106 and 124 transmitting packets out of the network topology 100A may be referred to as an egress network node (or simply, an egress node). Depending on the direction of packet traffic, each of the network nodes 106 and 124 may function as an ingress network node or an egress network node. The network nodes 108-122 forwarding packets in the network topology 100A may be referred to as a transit network node.

The customer edge 104 and network nodes 106-124 in FIG. 1A are coupled to, and communicate with each other, via links 150. The links 150 may be wired, wireless, or some combination thereof. The cost of every link is 1 by default except for the link between node P3 and node N1 with cost of 2, which is indicated by 2 on the link. For ease of reference, the various network nodes have been given a letter and number designation in FIG. 1A. For example, the content source 104 is designated CE, the network nodes 106-120 are designated A, P1-P4, N, N1, Q1, Q2, and C respectively.

In the depicted embodiment, CE 104 sends a packet 102 destined to node C. In a normal operating condition (i.e., node N is working well), node A, as an ingress node of SR-TE path (node A→node P1→node N→node Q1→node C), receives the packet 102 from CE 104, and then adds a segment list of the SR-TE path comprising node SID of P1 (SID-P1) 130, node SID of N (SID-N) 132, node SID of Q1 (SID-Q1) 134, and node SID of C (SID-C) 136 into the packet 102. In an embodiment, node A creates a packet named packet 1 comprising the segment list and packet 102. Node A then sends packet 1 (i.e., the packet 102 with the SID-P1 130, SID-N 132, SID-Q1 134, and SID-C 136) to node P1 along IGP shortest path. Node P1 pops/removes its SID-P1 130 from packet 1 to get a new packet named packet 2 and forwards packet 2 (i.e., the packet 102 with the SID-N 132 (i.e., current top SID in the segment list), SID-Q1 134, and SID-C 136) to the next hop node P3 towards node N along the IGP shortest path to node N. A top SID of a packet with a segment list (or say a list of SIDs or a SID list) is the first SID in the segment list. For example, packet 2 includes segment list <SID-N 132, SID-Q1 134, SID-C 136>. SID-N 132 is the top SID of packet 2 since SID-N 132 is the first SID in the segment list. Node P3 sends packet 3 (i.e., the packet 102 with the SID-N 132 (i.e., current top SID in the segment list), which is the same as packet 2) to node N. Node N removes its SID-N 132 from packet 3 to get packet 4 and sends packet 4 (i.e., the packet 102 with SID-Q1 134 (i.e., current top SID in the segment list) and SID-C 136) to node Q1. Node Q1 removes its SID-Q1 134 from packet 4 to get packet 5. Node Q1 sends packet 5 (i.e., the packet 102 with the segment list comprising just the SID-C 136 (i.e., current top SID in the segment list)) to node C, which removes its SID-C 136 from the segment list in packet 5 and obtains packet 6 (i.e., the packet 102 without any SIDs).

In FIG. 1A, assume that node N fails (e.g., node failure) or a link connected to node N fails (e.g., link failure), which makes it appear that node N fails. In existing solutions, when node N fails, its immediate neighbor (e.g., node P3) detects the failure of node N. Node P3 as a Point of Local Repair (PLR) node pops SID-N 132 from packet 2 received from node P1 to get packet 3′, performs a fast-reroute (FRR) protection and sends packet 3′ (i.e., the packet 102 with SID-Q1 134 and SID-C 136) to node Q1 via node N1 without going through failed N. Node N1 sends packet 4′ (i.e., the packet 102 with SID-Q1 134 (i.e., current top SID in the segment list) and SID-C 136, which is the same as packet 3′) to node Q1. Node Q1 removes its SID-Q1 134 from the segment list of packet 4′ to get packet 5. Node Q1 sends packet 5 (i.e., the packet 102 with the segment list comprising just the SID-C 136 (i.e., current top SID in the segment list)) to node C, which removes its SID-C 136 from the segment list in packet 5 and obtains packet 6 (i.e., the packet 102 without any SIDs).

IGP converges when all components of each router, including the Routing Information Base (RIB) and Forwarding Information Base (FIB), along with software and hardware tables, are provided with the most recent route change(s) such that forwarding for a route entry is successful on the Next-Best Egress Interface. The Next-Best Egress Interface is the outbound interface or set of outbound interfaces in an Equal Cost Multipath (ECMP) set or parallel link set of the router for traffic routed to the second-best next-hop. After IGP converges, every node (e.g., node A and node P1) of the SR-TE path going through node N (i.e., the SID of node N is in the segment list of a packet imported into the SR tunnel/path) to a destination (e.g., node C) deletes the route to the failed node N. In this case, the traffic to be transported by the SR tunnel/path cannot reach the neighbor node of node N because the forwarding entry for a node SID of the failed node N is deleted. Any traffic that arrives at the closest upstream endpoint node P1 with the node-SID of the failed node (i.e., node N) as the active segment will be dropped. Any traffic protection mechanism on the neighbor node of node N (e.g., node P3) is not used to send the traffic for the SR tunnel/path around the failed node N towards its destination since the traffic cannot reach to the neighbor node. Therefore, traffic cannot reach to the destination.

The disclosed embodiments provide an efficient solution for resolving the issue of traffic being dropped at a node because the forwarding entry for the node-SID of a failed node along a SR tunnel/path is deleted.

FIG. 1B is a schematic diagram illustrating an example network topology 100B of SR-TE MPLS path after IGP convergence on the failure according to an embodiment of the present disclosure. The network nodes and links depicted in FIG. 1B are similar to the network nodes and links depicted in FIG. 1A. For the sake of brevity, a detailed description of these elements is not repeated herein. In an embodiment, node A sends packet 1 (i.e., the packet 102 with the SID-P1 130, SID-N 132, SID-Q1 134, and SID-C 136) to node P1 along IGP shortest path. The non-neighbor upstream endpoint node P1 determines that SID-N 132 is a failed node SID of the node N along the SR-TE path when node N failed and after the IGP converges on the failure. In an embodiment, node P1 determines whether SID-N 132 is a failed node SID through checking whether there was a forwarding entry for SID-N 132 and then the forwarding entry for SID-N 132 is removed. Since SID-N 132 is a failed node SID, node P1 pops/removes its SID-P1 130 and SID-N 132 from packet I received from node A and obtains packet 2′ (i.e., the packet 102 with SID-Q1 134 and SID-C 136). Node P1 determines a current top SID in the segment list and then, sends, using FIB entry for the top SID, packet 2′ to a next hop node (e.g., node P4) along the IGP shortest path to the Q1 after the IGP has converged. Node P4 sends packet 3″ (which is the same as packet 2′) to N1 according to the current top SID (SID-Q1) in packet 3″. Node N1 sends packet 4″ (which is the same as packet 3″) to Q1 according to the top SID (SID-Q1) in packet 3″ received. Node Q1 removes its SID-Q1 134 from the segment list of packet 4″ received and obtains packet 5. Node Q1 sends packet 5 (i.e., the packet 102 with the segment list comprising just the SID-C 136 of node C) to node C, which removes its SID-C 136 from the segment list of packet 5 and obtains packet 6 (i.e., the packet 102). This way, the present disclosure extends the fast re-route protection for the failure of the transit node of the SR-TE MPLS path after the IGP converges on the failure.

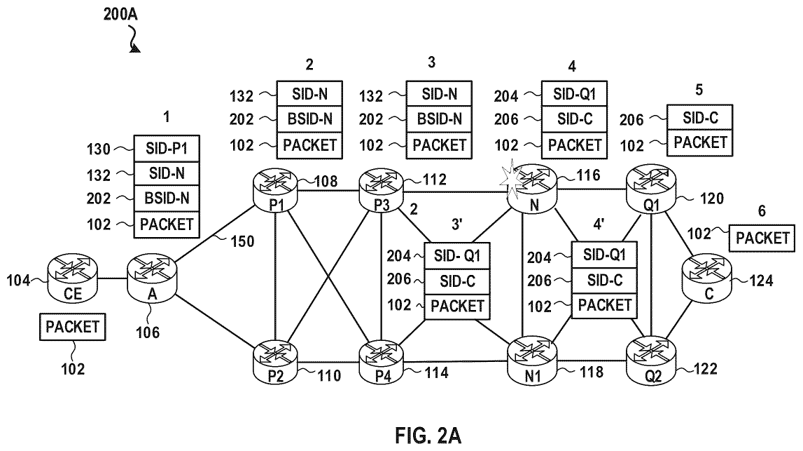

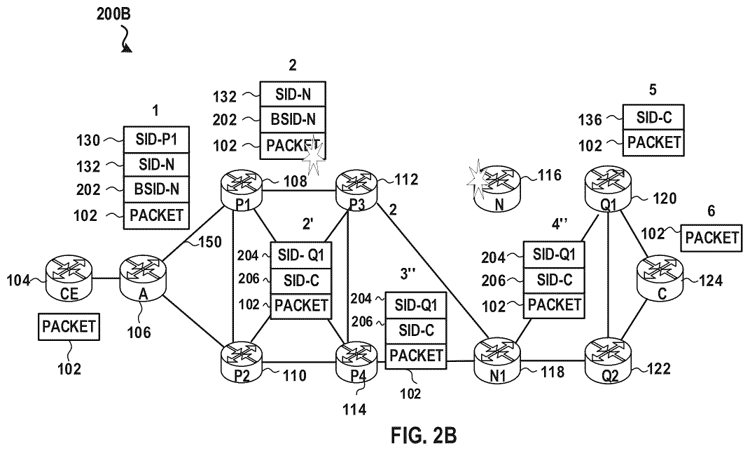

FIG. 2A is a schematic diagram illustrating an example network topology 200A of SR-TE MPLS path with binding SID (BSID) in normal operations and before IGP convergence on the failure according to an embodiment of the present disclosure. The network nodes and links depicted in FIG. 2A are similar to the network nodes and links depicted in FIG. 1A. For the sake of brevity, a detailed description of these elements is not repeated herein. In the depicted embodiment, CE 104 sends a packet 102 destined to a node C. In a normal operating condition (i.e., node N works well), node A, as ingress node of SR-TE path (node A →node P1→node N→node Q1→node C), receives the packet 102 from CE 104, and then adds a segment list of the SR-TE path comprising node SID of P1 (SID-P1) 130, node SID of N (SID-N) 132, and binding SID of node N (BSID-N) 202 into the packet 102. In an embodiment, node A creates a packet named packet 1 comprising the segment list and packet 102. The BSID-N (i.e., binding SID of node N) is associated with SID list comprising node SID of Q1 (SID-Q1) 204 and node SID of C (SID-C) 206.

In an embodiment, node A then sends packet 1 (i.e., the packet 102 with the SID-P1 130, SID-N 132, and BSID-N 202) to node P1 along IGP shortest path. Node P1 pops its SID-P1 130 from packet I received to obtain packet 2 and forwards packet 2 (i.e., the packet 102 with the SID-N 132 (i.e., current top SID in the segment list) and BSID-N 202) to the next hop node P3 towards node N along the IGP shortest path to node N. Node P3 sends packet 3 (i.e., the packet 102 with the SID-N 132 (i.e., current top SID in the segment list), which is the same as packet 2) to node N. Node N removes its SID-N 132 from packet 3 received, replaces its BSID-N 202 in packet 3 with SID list (SID-Q1 204 and SID-C 206) to obtain packet 4, and sends packet 4 (i.e., the packet 102 with SID-Q1 134 (i.e., current top SID in the segment list) and SID-C 206) to node Q1. Node Q1 removes its SID-Q1 134 from packet 4 received to obtain packet 5. Node Q1 sends packet 5 (i.e., the packet 102 with the segment list comprising just the SID-C 136 (i.e., current top SID in the segment list)) to node C, which removes its SID-C 136 from packet 5 received and obtains packet 6 (i.e., the packet 102 without any SIDs).

In FIG. 2A, assume that node N fails (e.g., node failure) or a link connected to node N fails (e.g., link failure), which makes it appear that node N fails. In existing solutions, when node N fails, its immediate neighbor (e.g., node P3) detects the failure of node N. Node P3 as a Point of Local Repair (PLR) node pops SID-N 132 from packet 2, replaces BSID-N 202 in packet 2 received from node P1 to obtain packet 3′ (i.e., the packet 102 with SID list (SID-Q1 204 and SID-C 206)), and performs a fast-reroute (FRR) protection and sends packet 3′ to node Q1 via node N1 without going through failed node N. Node N1 sends packet 4′ (i.e., the packet 102 with SID-Q1 134 (i.e., current top SID in the segment list) and SID-C 136, which is the same as packet 3′) to node Q1. Node Q1 removes its SID-Q1 134 from the segment list of the packet 4′ to obtain packet 5. Node Q1 sends packet 5 (i.e., the packet 102 with the segment list comprising just the SID-C 136 (i.e., current top SID in the segment list)) to node C, which removes its SID-C 136 from the segment list in packet 5 and obtains packet 6 (i.e., the packet 102 without any SIDs).

IGP converges when all components of each router, including the Routing Information Base (RIB) and Forwarding Information Base (FIB), along with software and hardware tables, are provided with the most recent route change(s) such that forwarding for a route entry is successful on the Next-Best Egress Interface. After IGP converges, every node (e.g., node A and node P1) of the SR-TE path going through node N (i.e., the SID of node N is in the segment list of a packet imported into the SR tunnel/path) to a destination (e.g., node C) deletes the route to the failed node N. In this case, the traffic to be transported by the SR tunnel/path cannot reach to the neighbor node of node N because the forwarding entry for SID-N is deleted. Any traffic that arrives at node P1 with the node-SID of the failed node (i.e., node N) as the active segment will be dropped. Any traffic protection mechanism on the neighbor node of node N (e.g., node P3) is not used to send the traffic for the SR tunnel/path around the failed node N towards its destination since the traffic cannot reach to the neighbor node. Therefore, traffic cannot reach to the destination.

The disclosed embodiments provide an efficient solution for resolving the issue of traffic being dropped at a node because the forwarding entry for the node-SID of a failed node along a SR tunnel/path is deleted.

FIG. 2B is a schematic diagram illustrating a network 200B after IGP convergence on the failure with binding SID of node N (BSID-N) according to an embodiment of the present disclosure. The network nodes and links depicted in FIG. 2B are similar to the network nodes and links depicted in FIG. 2A. For the sake of brevity, a detailed description of these elements is not repeated herein. In an embodiment, node A sends packet 1 (i.e., the packet 102 with the SID-P1 130, SID-N 132, and BSID-N 202) to node P1 along IGP shortest path. The non-neighbor upstream endpoint node P1 determines that SID-N 132 is a failed node SID of the node N along the SR-TE path when node N failed and after the IGP converges on the failure. In an embodiment, node P1 determines whether SID-N 132 is a failed node SID through checking whether there was a forwarding entry for SID-N 132 and then the forwarding entry for SID-N 132 is removed. Since SID-N 132 is a failed node SID, node P1 pops/removes its SID-P1 130 and SID-N 132 from packet 1 received from node A and replaces BSID-N 202 in packet 1 with SID list (i.e., SID-Q1 204 and SID-C 206) to obtain packet 2′. Then, node P1 determines a current top SID in the segment list and sends, using FIB entry for the top SID, packet 2′ to a next hop node (e.g., node P4) along the IGP shortest path to the node Q1 after the IGP has converged. Node P4 sends packet 3″ (which is the same as packet 2′) to node N1 according to the current top SID (SID-Q1 204) in packet 3″. Node N1 sends packet 4″ (which is the same as packet 3″) to node Q1 according to the top SID (SID-Q1 204) in the packet 3″ received. Node Q1 removes its SID-Q1 204 from the segment list of the packet 4″ received and obtains packet 5. Node Q1 sends packet 5 (i.e., the packet 102 with the segment list containing just the SID-C 206 of node C) to node C, which removes its SID-C 206 from the segment list in packet 5 and obtains packet 6 (i.e., the packet 102). This way the disclosed embodiments describe a simple mechanism to extend the fast re-route protection for the failure on an SR-MPLS path with BSID-N after the IGP converges on the failure.

### Procedure on Non-Neighbor Upstream Node

In an embodiment, after node N failed and from the IGP convergence on the failure to global reroute, the non-neighbor upstream endpoint node (i.e., node P1 as shown in FIG. 1B and FIG. 2B) of node N pops its SID-P1 from the packet if any, pops SID-N from the packet and performs one of the following. In a first case, when the current top SID following the node SID of node N in the packet is a node SID of a node named Nx, node P1 sends the packet toward Nx (i.e., next hop node of the failed node along the SR-TE path) along the IGP shortest path to Nx. In a second case, when the current top SID in the packet following the node SID of node N is an adjacency SID of node N, node P1 obtains a remote node of the adjacency from the adjacency SID, replaces the adjacency SID with a node SID of the remote node, and sends the packet toward the remote node along the IGP shortest path to the remote node. In a third case, when the current top SID following the node SID of node N is a binding SID (BSID) of the node N, node P1 replaces the BSID in the packet with the SID list associated with the BSID, and performs the first case or the second case according to the current top SID in the packet (i.e., performs the first case when the top SID is a node SID or performs the second case when the top SID is an adjacency SID of node N).

In another embodiment, when the top SID in the list is the adjacency SID of node N, the upstream (or previous) hop node of node N obtains the remote node of the adjacency from the adjacency SID and replaces the adjacency SID in the list with the node SID of the remote node. The upstream (or previous) hop node replaces the binding SID in the packet with the SID list and sends the packet towards the top SID in the packet along the IGP shortest path to the top SID.

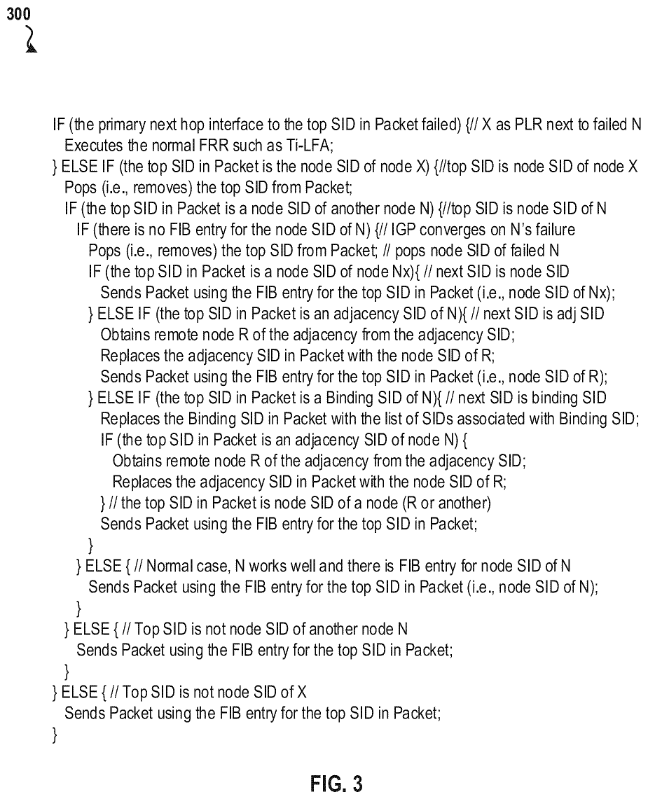

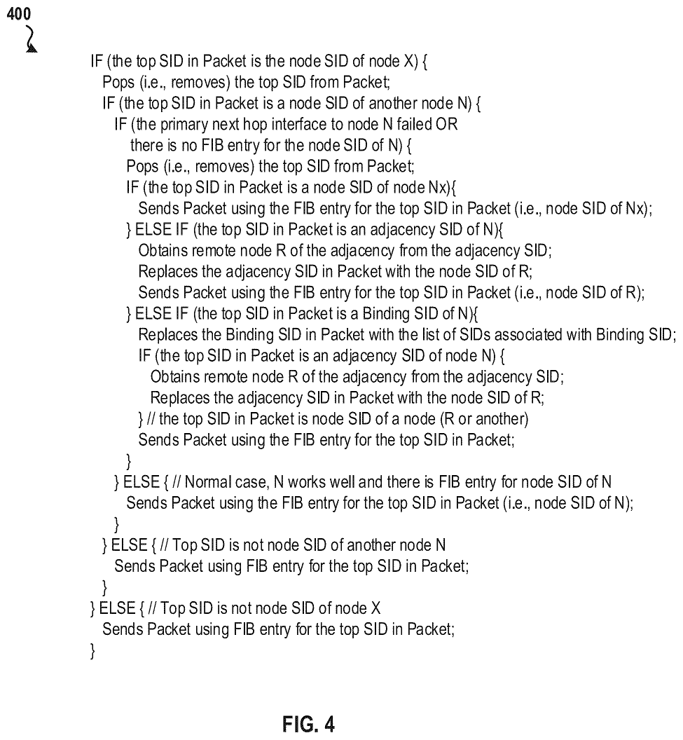

FIG. 3 and FIG. 4 illustrate an algorithm used to implement a procedure on a non-neighbor upstream endpoint node on an SR-TE MPLS path according to an embodiment of the disclosure. In particular, the algorithms 300 and 400 may be used to implement an integrated procedure running on the non-neighbor upstream endpoint node that forwards the packet to be transported by a SR-TE path in normal operations (i.e., there is no failure along the path) and the case that a node on the path failed as described above.

### Binding Information Distribution

The present disclosure further describes extensions to path computation element protocol (PCEP) for distributing binding protection information to an upstream neighbor node (e.g. node P3) of a node (e.g., node N) or a closest upstream endpoint node (e.g. node P1) of the node on SR-TE path that may protect the binding SID of the node. A PCE controller is used to distribute a binding to the node or receive the binding from the node. The binding includes a binding SID of the node (BSID-N) and a path represented by a first list of SIDs (SID-list 1) associated with BSID-N. In an embodiment, when a controller implementing PCEP (or simply, a PCE controller) sends the BSID-N associated with the first list of SIDs to the node or receives the BSID-N associated with the first list of SIDs from the node, the PCE controller uses PCEP extensions to also send binding protection information (or simply, binding protection or binding for protection) to the upstream neighbor node on the SR-TE path and the closest upstream endpoint node (or simply, upstream endpoint node) of the node on the SR-TE path.

In an embodiment, the binding protection information comprises BSID-N, a second list of SIDs (SID-list 2) corresponding to the SID-list 1, and an identifier of the node (ID-N). In an embodiment, the PCE controller may further send an instruction to the upstream neighbor node to use the binding protection information (i.e., the BSID-N, SID-list 2, and ID-N) for protecting the binding SID of the failed node if the node fails. In one embodiment, the binding protection information is the instruction. In an embodiment, the binding protection information may be sent to the closest upstream endpoint node if the node is a loose hop and the upstream endpoint node is not the neighbor of the node. In one embodiment, the first SID in SID-list 1 is the adjacency SID of the adjacency from the node to a remote node. In one embodiment, SID-list 2 comprises the node SID of the remote node and all the SIDs in SID-list 1 except for the first SID. Thus, SID-list 2 is generated by replacing the first SID in SID-list 1 with the node SID of the remote node. In another embodiment, the first SID in SID-list 1 is a node SID, and SID-list 2 is the same as SID-list 1.

In an embodiment, when an upstream endpoint node (e.g. node P1) of the node on the SR-TE path receives the binding protection information comprising BSID-N, SID-list 2, and ID-N, the upstream endpoint node creates a FIB entry for BSID-N of the node with ID-N. The FIB entry instructs the upstream endpoint node to replace BSID-N in the packet with SID-list 2 and sends the packet along the shortest path to the top SID in the packet according to the FIB entry for the top SID. When there is no FIB entry for node SID of the node (SID-N) as the top SID of a packet received, which is followed by BSID-N, the endpoint node uses this FIB entry after popping (i.e., removing) SID-N.

In an embodiment, when an upstream neighbor node (e.g., node P3) of the node on the SR-TE path receives the binding protection information comprising BSID-N, SID-list 2 and ID-N, the neighbor node creates a FIB entry for BSID-N of the node with ID-N. The FIB entry instructs the neighbor node to replace BSID-N in the packet with SID-list 2 and performs one of the following. In the first case, the neighbor node sends the packet to the top SID in the packet without going through the node when the upstream neighbor node detects the failure of the node (i.e., the node failed and before IGP converges on the failure of the node). In the second case, the neighbor node sends the packet along the shortest path to the top SID in the packet according to the FIB entry for the top SID when there is no path (i.e., FIB entry) to the node (i.e., the node failed and after IGP converges on the failure of the node).

In an embodiment, for an adjacency SID of a node such as node N in FIG. 2A for an SR path with the adjacency SID, adjacency protection information is sent to the upstream neighbor of the node on the SR path. The adjacency protection information comprises 1) an adjacency SID of the node: SID-N-R, which is the adjacency SID of the adjacency from node N to remote node R, 2) a node SID of a remote node (SID-R) of the adjacency indicated by SID-N-R, and 3) an identifier (ID) of the node (ID-N).

In an embodiment, the adjacency protection information is sent to the closest upstream endpoint node (e.g., P1 on SR-TE path 1 in FIG. 2A) of the node (e.g., node N in FIG. 2A) if the node is a loose hop and the endpoint node is not an upstream neighbor of the node on the SR path.

In an embodiment, when an upstream endpoint node of the node on the SR path receives the adjacency protection information SID-N-R, SID-R and ID-N, the endpoint node creates a FIB entry for SID-N-R of the node with ID-N. This FIB entry instructs the endpoint node to replace SID-N-R in the packet with SID-R and sends the packet along the shortest path to SID-R according to the FIB entry for SID-R. When there is no FIB entry for node SID of the node (SID-N) as the top SID of a packet received, which is followed by SID-N-R, the endpoint node uses this FIB entry after popping (i.e., removing) SID-N.

In an embodiment, when an upstream neighbor node of the node on the SR path receives the adjacency protection information SID-N-R, SID-R and ID-N, the neighbor node creates a FIB entry for SID-N-R of the node with ID-N. This FIB entry instructs the neighbor node to replace SID-N-R in the packet with SID-R and performs one of the following: 1) the neighbor node sends the packet to SID-R without going through the node when the upstream neighbor node detects the failure of the node (i.e., when the node failed and before IGP converges on the failure of the node), and 2) the neighbor node sends the packet along the shortest path to SID-R according to the FIB entry for SID-R when there is no path (i.e., FIB entry) to the node (i.e., when the node failed and after IGP converges on the failure of the node).

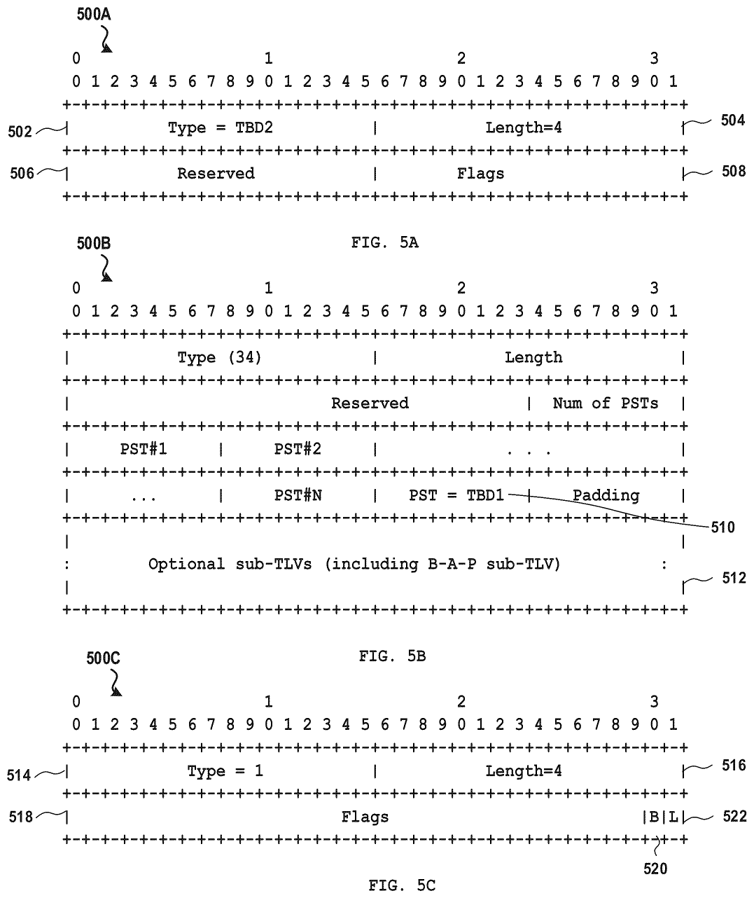

FIGS. 5A-5C are schematic diagrams illustrating Type-Length-Value (TLV) and sub-TLV structures used to indicate a capability of distributing binding for protection according to an embodiment of the present disclosure. In an embodiment, a path computation client (PCC) may run on each node in the network topology 200A and 200B. The PCE controller runs on a server as a controller to communicate with PCCs. The PCE controller and the PCCs work together to distribute the binding protection information about a binding SID on a node to the possible upstream nodes for protecting the binding SID of the node if the node fails. When the PCE controller and a PCC running on a network node establish a PCEP session between them, the PCE controller and the PCC running on the node (or, simply PCC node) exchange capabilities of distributing binding and adjacency protection information in Open messages. An Open message includes an Open object. The Open object comprises a PATH_SETUP_TYPE_CAPABILITY TLV with Path Setup Type (PST) and a plurality of sub-TLVs including binding-adjacency protection capability (B-A-P) sub-TLV.

FIG. 5A is a schematic diagram illustrating a format of a binding-adjacency protection capability (B-A-P) sub-TLV according to an embodiment of the present disclosure. The format of B-A-P sub-TLV 500A comprises a type field 502, a length field 504, a reserved field 506, and a flags field 508. In an embodiment, the type field 502 comprises a value to be determined (TBD2) and to be assigned by Internet Assigned Numbers Authority (IANA). The length field 504 comprises a value of 4. The reserved field 506 is 2 octets. The flags field 508 is 2 octets.

FIG. 5B represents a format of PATH_SETUP_TYPE_CAPABILITY TLV 500B comprising a Path Setup Type (PST) field 510 and a sub-TLVs field 512. In an embodiment, the PST field 510 comprises a value (TBD1) that indicates that the PCEP speaker (the PCE server as a controller or the PCC node) is capable of receiving and distributing binding and adjacency protection information. The sub-TLVs field 512 comprises B-A-P sub-TLV 500A as shown in FIG. 5A.

FIG. 5C is a schematic diagram illustrating a format of a PCECC-CAPABILITY sub-TLV 500C according to an embodiment of the present disclosure. In another embodiment, when PCE as a central controller (PCECC) is used, a PCC on a neighbor node and PCE exchange capability of distributing binding and adjacency protection information using PCECC-CAPABILITY sub-TLV 500C which is included in the PATH_SETUP_TYPE_CAPABILITY TLV in an Open message.

The PCECC-CAPABILITY sub-TLV 500C comprises a type field 514, a length field 516, and a flags field 518 including a B flag field 520 and a L flag field 522. In an embodiment, the type field 514 comprises a value of 1. The length field 516 comprises a value of 4. The B flag field 520 is defined for binding and adjacency protection. The B flag field 520 set to a value (e.g., 1) by a PCEP speaker (PCE or PCC) that indicates that the PCEP speaker supports and is willing to handle the PCECC-based central controller instructions for binding and adjacency protection. The B flag field 520 is set to 1 by both a PCC node and a PCE controller for downloading/reporting the PCECC binding and adjacency protection instruction on a PCEP session.

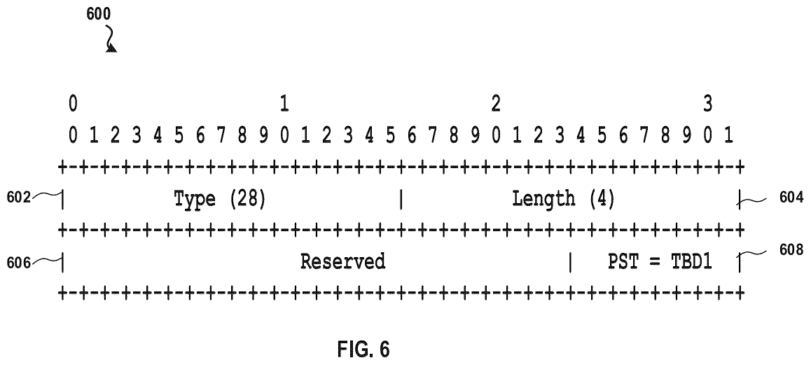

FIG. 6 is a schematic diagram illustrating a format of a PATH-SETUP-TYPE TLV 600 according to an embodiment of the present disclosure. In an embodiment, after sending the binding and/or adjacency information to a node or receiving the binding and/or adjacency information from the node, the PCE controller sends the corresponding binding protection information of the related nodes in a PCEP message. In an embodiment, the PCEP message is a Path Computation LSP Update Request (PCUpd) message. The PCUpd message comprises a request parameters (RP) object or stateful PCE request parameters (SRP) object. The RP/SRP object includes PATH-SETUP-TYPE TLV 600 comprising a type field 602, a length field 604, a reserved field 606, and a Path Setup Type (PST) field 608. In an embodiment, the PST field 608 comprises a value (TBD1) that comprises binding and adjacency protection information for a node for protecting the binding or adjacency SID of the node. The RP/SRP object further includes node ID TLV comprising an identifier of the node and a TLV comprising BSID TLV comprising a BSID of a node, SID-List TLV comprising a list of SIDs, an adjacency SID (ASID) TLV comprising an adjacency SID of a node, or an NSID TLV comprising a node SID of the remote node of the adjacency indicated by the adjacency SID.

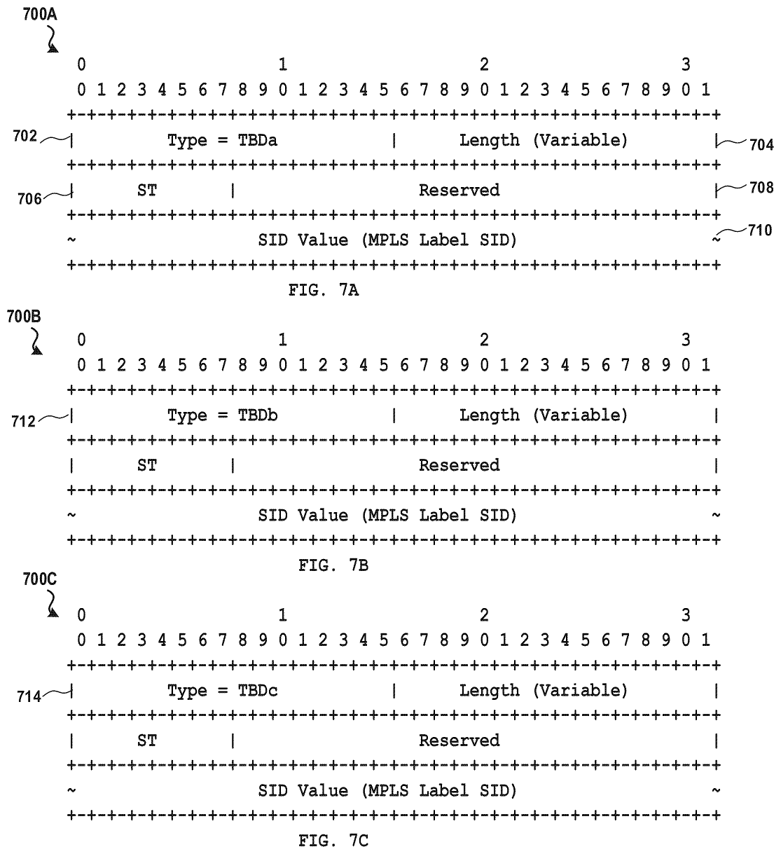

FIG. 7A is a schematic diagram illustrating a format of a BSID TLV 700A according to an embodiment of the present disclosure. The format of BSID TLV 700A comprises a type field 702, a length field 704, a SID Type (ST) field 706, a reserved field 708, and a SID value field 710. In an embodiment, the type field 702 comprises a value to be determined (TBDa) and to be assigned by IANA. The length field 704 is variable. The ST field 706 is 1 octet field that identifies the type of SID in TLV. In one case, the ST field 706 set to a value (e.g., 1) indicates that SID is a 20-bit MPLS label. The TLV is padded to 4-bytes alignment and the length field 704 is set to 7. In one case, the ST field 706 set to a value (e.g., 2) indicates that SID is a 32-bit MPLS label stack entry. The SID value field 710 comprises a value of a BSID.

FIG. 7B is a schematic diagram illustrating a format of an ASID TLV 700B according to an embodiment of the present disclosure. The format of ASID TLV 700B in FIG. 7B are similar as depicted in FIG. 7A. For the sake of brevity, a detailed description of is not repeated herein. The format of ASID TLV 700B comprises a type field 712. The type field 712 comprises a value to be determined (TBDb) and to be assigned by IANA. The SID value field comprises a value of an adjacency SID.

FIG. 7C is a schematic diagram illustrating a format of an NSID TLV 700C according to an embodiment of the present disclosure. The format of NSID TLV 700C in FIG. 7C are similar as depicted in FIG. 7A. For the sake of brevity, a detailed description of is not repeated herein. The format of NSID TLV 700C comprises a type field 714. The type field 714 comprises a value to be determined (TBDc) and to be assigned by IANA. The SID value field comprises a value of a node SID.

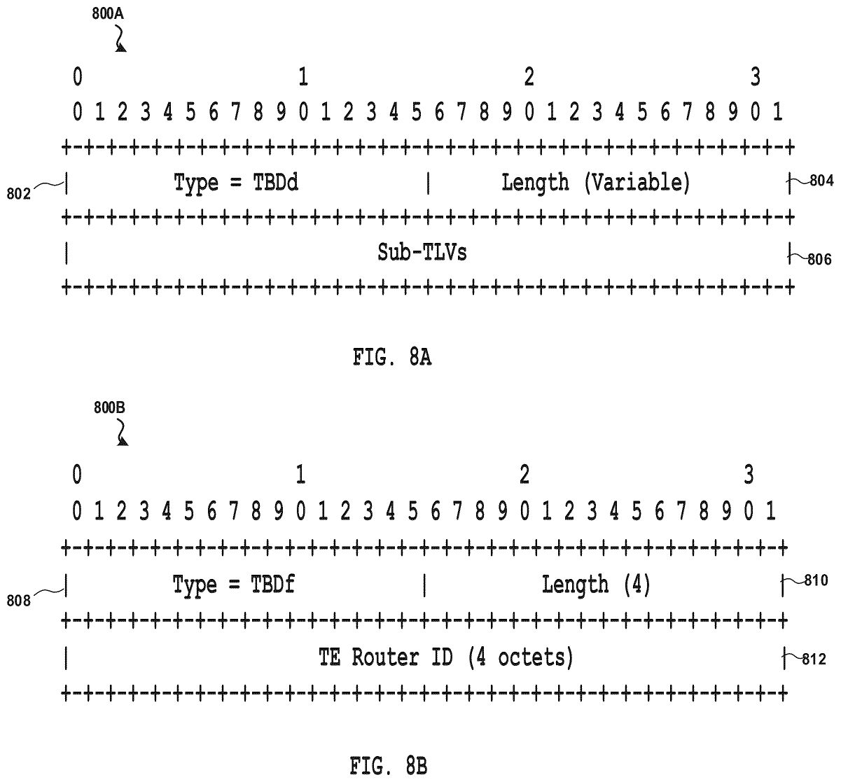

FIG. 8A is a schematic diagram illustrating a format of SID-list TLV 800A according to an embodiment of the present disclosure. The format of SID-list TLV 800A comprises a type field 802, a length field 804, and a sub-TLVs field 806. In an embodiment, the type field 802 comprises a value to be determined (TBDd) and to be assigned by IANA. The length field 804 is variable. The sub-TLVs field 806 comprises a number of Sub-TLVs. Each Sub-TLV is a NSID TLV, an ASID TLV, or a BSID TLV as shown in FIGS. 7A-7C.

FIG. 8B is a schematic diagram illustrating a format of TE router ID TLV 800B according to an embodiment of the present disclosure. In one embodiment, Node ID TLV is a TE Router ID TLV 800B. The TE Router ID TLV comprises the TE router identifier (ID). The format of a TE Router ID TLV 800B comprises a type field 808, a length field 810, and a TE router ID 812. In an embodiment, the type field 808 comprises a value to be determined (TBDf) and to be assigned by IANA. The length field 810 is set as 4.

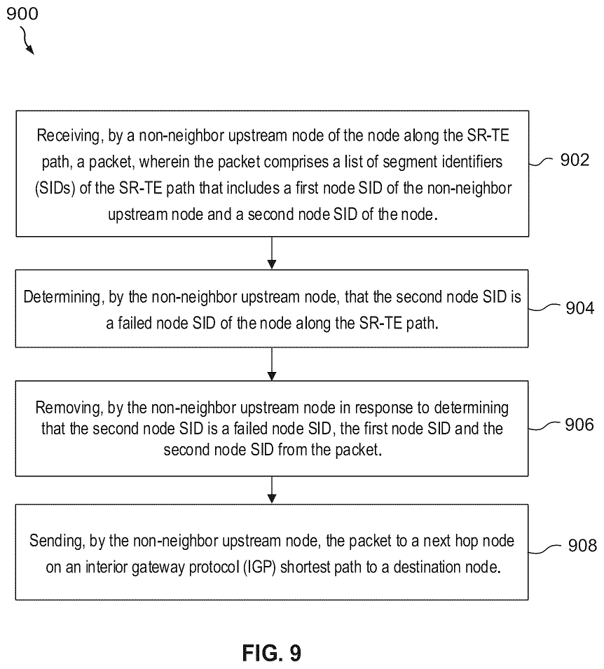

FIG. 9 is a flowchart illustrating a method 900 for enabling traffic to continue to be forwarded on an SR-TE path after a failure of a node according to an embodiment of the present disclosure. The method 900 can be performed by a non-neighbor upstream endpoint node of a failed node. For example, in FIG. 1B, node P1 can be a non-neighbor upstream endpoint node for node N in the event that node N fails. In block 902, the non-neighbor upstream endpoint node receives a packet, wherein the packet comprises a list of segment identifiers (SIDs) of the SR-TE path that includes a first node SID of the non-neighbor upstream endpoint node and a second node SID of the node. In block 904, the non-neighbor upstream endpoint node determines the second node SID is a failed node SID of the node along the SR-TE path. In an embodiment, if there was a forwarding entry for the second node SID and then the forwarding entry for the second node SID is removed, then the second node SID is a failed node SID. In block 906, the non-neighbor upstream endpoint node removes, in response to determining that the second node SID is a failed node SID of the node, the first node SID and the second node SID from the packet. In block 908, the non-neighbor upstream endpoint node sends the packet to a next hop node towards a destination node along the IGP shortest path to the destination node after the IGP has converged.

The method 900 may implement additional embodiments. For instance, the non-neighbor upstream endpoint node sends the packet towards a node Nx along the IGP shortest path to the node Nx when a top SID of the packet is a node SID of the node Nx, wherein Nx is a next hop node of the failed node along the SR-TE path. In an embodiment, when a top SID of the packet is an adjacency SID of the node, the method 900 may further comprise obtaining, by the non-neighbor upstream endpoint node, a remote node of the adjacency from the adjacency SID; replacing, by the non-neighbor upstream endpoint node, the adjacency SID with a node SID of the remote node; and sending, by the non-neighbor upstream endpoint node, the packet towards the remote node along the IGP shortest path to the remote node.

In an embodiment, when a top SID of the packet is a binding SID (BSID) of the node, the method 900 may further comprise replacing, by the non-neighbor upstream endpoint node, the BSID in the packet with a second list of SIDs associated with the BSID; and sending, by the non-neighbor upstream endpoint node, the packet to a next hop node towards a destination node along the IGP shortest path to the destination node after the IGP has converged.

In an embodiment, when a top SID of the packet is a binding SID (BSID) of the node, the method 900 may further comprise replacing, by the non-neighbor upstream endpoint node, the BSID in the packet with a second list of SIDs associated with the BSID; and when the top SID is an adjacency SID of the node, obtaining, by the non-neighbor upstream endpoint node, a remote node of the adjacency from the adjacency SID; replacing, by the non-neighbor upstream endpoint node, the adjacency SID with a node SID of the remote node; and sending, by the non-neighbor upstream endpoint node, the packet towards the remote node along the IGP shortest path to the remote node.

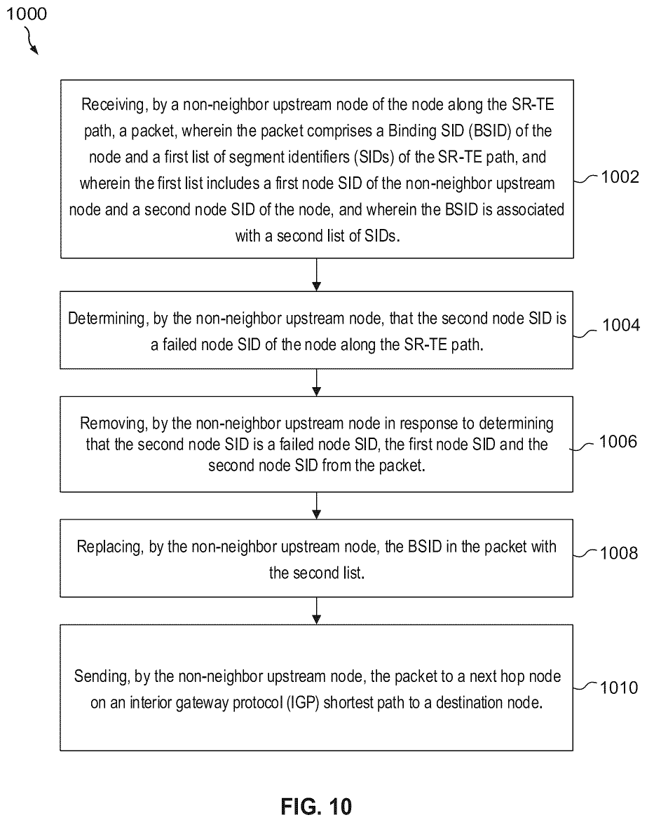

FIG. 10 is a flowchart illustrating a method 1000 for enabling traffic to continue to be forwarded on an SR-TE path after a failure of a node according to an embodiment of the present disclosure. The method 1000 can be performed by a non-neighbor upstream endpoint node of a failed node. For example, in FIG. 1B and FIG. 2B, node P1 can be a non-neighbor upstream endpoint node for node N in the event that node N fails. In block 1002, the non-neighbor upstream endpoint node receives a packet, wherein the packet comprises a binding SID (BSID) of the node and a first list of segment identifiers (SIDs) of the SR-TE path, and wherein the first list includes a first node SID of the non-neighbor upstream endpoint node and a second node SID of the node, and wherein the BSID is associated with a second list of SIDs. In block 1004, the non-neighbor upstream endpoint node determines that the second node SID is a failed node SID of the node along the SR-TE path. In an embodiment, if there was a forwarding entry for the second node SID and then the forwarding entry for the second node SID is removed, then the second node SID is a failed node SID. In block 1006, the non-neighbor upstream endpoint node removes, in response to determining that the second node SID is a failed node SID of the node, the first node SID and the second node SID from the packet. In block 1008, the non-neighbor upstream endpoint node replaces the BSID in the packet with the second list. In block 1010, the non-neighbor upstream endpoint node sends the packet to a next hop node towards a destination node along the IGP shortest path to the destination node after the IGP has converged.

The method 1000 may implement additional embodiments. For instance, the non-neighbor upstream endpoint node may receive a first message from a path computation element (PCE) controller, wherein the first message comprises binding protection information corresponding to binding information of the node, wherein the binding information includes the BSID and the second list, and wherein the binding protection information includes the BSID, a third list of SIDs corresponding to the second list, an identifier (ID) of the node, and an instruction; and using, by the non-neighbor upstream endpoint node based on the instruction, the binding protection information to protect the BSID of the failed node when the node fails.

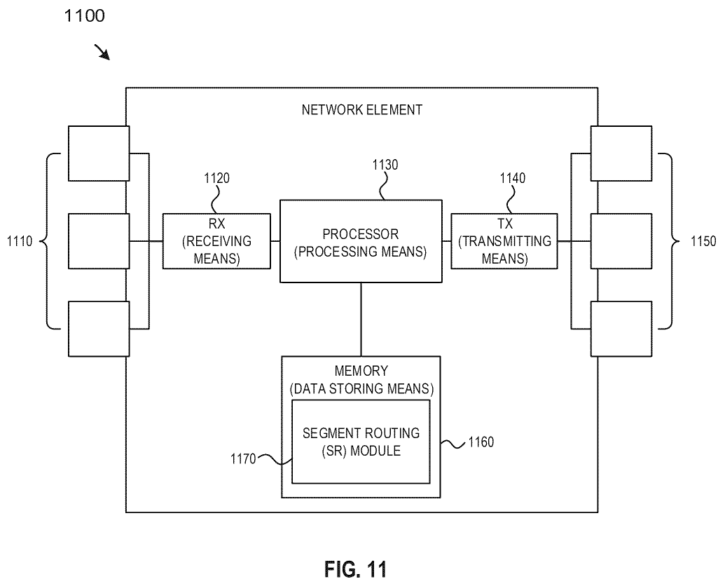

FIG. 11 is a schematic diagram illustrating a network element 1100 according to an embodiment of the present disclosure. The network element 1100 can be any type of network node, controller, router, and switch such as, but not limited to, node P1 and node N in FIG. 1A. The network element 1100 includes receiver units (RX) 1120 or receiving means for receiving data via ingress ports 1110. The network element 1100 also includes transmitter units (TX) 1140 or transmitting means for transmitting via data egress ports 1150.

The network element 1100 includes a memory 1160 or data storing means for storing the instructions and various data. The memory 1160 can be any type of or combination of memory components capable of storing data and/or instructions. For example, the memory 1160 can include volatile and/or non-volatile memory such as read-only memory (ROM), random access memory (RAM), ternary content-addressable memory (TCAM), and/or static random-access memory (SRAM). The memory 1160 can also include one or more disks, tape drives, and solid-state drives. In some embodiments, the memory 1160 can be used as an over-flow data storage device to store programs when such programs are selected for execution, and to store instructions and data that are read during program execution.

The network element 1100 has one or more processor 1130 or other processing means (e.g., central processing unit (CPU)) to process instructions. The processor 1130 may be implemented as one or more CPU chips, cores (e.g., as a multi-core processor), field-programmable gate arrays (FPGAs), application specific integrated circuits (ASICs), and digital signal processors (DSPs). The processor 1130 is communicatively coupled via a system bus with the ingress ports 1110, RX 1120, TX 1140, egress ports 1150, and memory 1160. The processor 1130 can be configured to execute instructions stored in the memory 1160. Thus, the processor 1130 provides a means for performing any computational, comparison, determination, initiation, configuration, or any other action corresponding to the claims when the appropriate instruction is executed by the processor. In some embodiments, the memory 1160 can be memory that is integrated with the processor 1130.

In one embodiment, the memory 1160 stores a SR module 1170. The SR module 1170 includes data and executable instructions for implementing the disclosed embodiments. For instance, the SR Module 1170 can include instructions for implementing the methods described in FIGS. 1A-1B and FIGS. 2A-2B described herein. The inclusion of the SR module 1170 substantially improves the functionality of the network element 1100 by enabling traffic to continue to be forwarded on an SR-TE path after a failure of a node whose node-SID is in a segment list of the SR-TE paths without having to immediately modify the segment list used at an ingress node to the SR-TE path.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the disclosure is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

Following the claims below is a document that may be submitted to a standards body and which embodies the present disclosure.

What is claimed is:

1. A method for enabling traffic to continue to be forwarded on a Segment Routing Traffic Engineering (SR-TE) path after a failure of a node along the SR-TE path, the method comprising:
receiving, by a non-neighbor upstream endpoint node of the node along the SR-TE path, a packet, wherein the packet comprises a list of segment identifiers (SIDs) of the SR-TE path that includes a first node SID of the non-neighbor upstream endpoint node and a second node SID of the node;
determining, by the non-neighbor upstream endpoint node, that the second node SID is a failed node SID of the node along the SR-TE path;
removing, by the non-neighbor upstream endpoint node in response to determining that the second node SID is the failed node SID of the node, the first node SID and the second node SID from the packet; and
sending, by the non-neighbor upstream endpoint node, the packet to a next hop node on an interior gateway protocol (IGP) shortest path to a destination node.

2. The method of claim 1, further comprising sending the packet towards a node Nx along the IGP shortest path to the node Nx when a top SID of the packet is a node SID of the node Nx, wherein Nx is a next hop node of a failed node corresponding to the failed node SID along the SR-TE path.

3. The method of claim 1, wherein when a top SID of the packet is an adjacency SID of the node, the method further comprises:
obtaining, by the non-neighbor upstream endpoint node, a remote node associated with the adjacency SID;
replacing, by the non-neighbor upstream endpoint node, the adjacency SID with a node SID of the remote node; and
sending, by the non-neighbor upstream endpoint node, the packet towards the remote node along the IGP shortest path to the remote node.

4. The method of claim 1, wherein when a top SID of the packet is a binding SID (BSID) of the node, the method further comprises:
replacing, by the non-neighbor upstream endpoint node, the BSID in the packet with a second list of SIDs associated with the BSID; and
sending, by the non-neighbor upstream endpoint node, the packet to a next hop node towards a destination node along the IGP shortest path to the destination node after the IGP has converged.

5. The method of claim 1, wherein when a top SID of the packet is a binding SID (BSID) of the node, the method further comprises:
replacing, by the non-neighbor upstream endpoint node, the BSID in the packet with a second list of SIDs associated with the BSID; and
when the top SID is an adjacency SID of the node,
obtaining, by the non-neighbor upstream endpoint node, a remote node associated with the adjacency SID;
replacing, by the non-neighbor upstream endpoint node, the adjacency SID with a node SID of the remote node; and
sending, by the non-neighbor upstream endpoint node, the packet towards the remote node along the IGP shortest path to the remote node.

6. A method for enabling traffic to continue to be forwarded on a Segment Routing Traffic Engineering (SR-TE) path after a failure of a node along the SR-TE path, the method comprising:
receiving, by a non-neighbor upstream endpoint node of the node along the SR-TE path, a packet, wherein the packet comprises a binding SID (BSID) of the node and a first list of segment identifiers (SIDs) of the SR-TE path, and wherein the first list includes a first node SID of the non-neighbor upstream endpoint node and a second node SID of the node, and wherein the BSID is associated with a second list of SIDs;
determining, by the non-neighbor upstream endpoint node, that the second node SID is a failed node SID of the node along the SR-TE path;
removing, by the non-neighbor upstream endpoint node in response to determining that the second node SID is the failed node SID of the node, the first node SID and the second node SID from the packet;
replacing, by the non-neighbor upstream endpoint node, the BSID in the packet with the second list; and
sending, by the non-neighbor upstream endpoint node, the packet to a next hop node on an interior gateway protocol (IGP) shortest path to a destination node.

7. The method of claim 6, further comprising sending the packet towards a node Nx along the IGP shortest path to the node Nx when a top SID of the packet is a node SID of the node Nx.

8. The method of claim 6, wherein when a top SID of the packet is an adjacency SID of the node, the method further comprises:
obtaining, by the non-neighbor upstream endpoint node, a remote node associated with the adjacency SID;
replacing, by the non-neighbor upstream endpoint node, the adjacency SID with a node SID of the remote node; and
sending, by the non-neighbor upstream endpoint node, the packet towards the remote node along the IGP shortest path to the remote node.

9. The method of claim 6, further comprising:
receiving, by the non-neighbor upstream endpoint node, a first message, wherein the non-neighbor upstream endpoint node receives the first message from a path computation element (PCE) controller, wherein the first message comprises binding protection information corresponding to binding information of the node, wherein the binding information includes the BSID and the second list, and wherein the binding protection information includes the BSID, a third list of SIDs corresponding to the second list, an identifier (ID) of the node, and an instruction; and
using, by the non-neighbor upstream endpoint node based on the instruction, the binding protection information to protect the BSID of a failed node corresponding to the failed node SID when the node fails.

10. The method of claim 9, further comprising exchanging a capability of distributing the binding protection information and adjacency protection information with the non-neighbor upstream endpoint node in a PATH_SETUP_TYPE_CAPABILITY type length value (TLV) with a Path Setup Type (PST) and a sub-TLV in an Open object of an Open message.

11. The method of claim 10, wherein the sub-TLV comprises a type field, a length field, a reserved field, and a flags field.

12. The method of claim 9, further comprising exchanging a capability of distributing the binding protection information and adjacency protection information with the non-neighbor upstream endpoint node using a PCECC-CAPABILITY Sub-TLV comprised in a PATH_SETUP_TYPE_CAPABILITY TLV in an Open message.

13. The method of claim 12, wherein the PCECC-CAPABILITY Sub-TLV comprises a B flag field set to a value indicating that a PCEP speaker supports the binding protection information and adjacency protection information distribution.

14. The method of claim 9, wherein the first message is a path computation update request (PCUpd) message.

15. The method of claim 14, wherein the PCUpd message comprises a Request Parameters (RP) object or Stateful Request Parameters (SRP) object, and wherein the RP/SRP object comprises a PATH-SETUP-TYPE TLV with a Path Setup Type (PST), a BSID TLV comprising the BSID of the node, SID-List TLV comprising a list of SIDs, and a node ID TLV comprising the identifier of the node.

16. The method of claim 14, wherein the PCUpd message comprises a Request Parameters (RP) object or Stateful Request Parameters (SRP) object, and wherein the RP/SRP object comprises a PATH-SETUP-TYPE TLV with a Path Setup Type (PST), adjacency SID (ASID) TLV comprising an adjacency SID of a node, a node SID (NSID) TLV comprising a node SID of a remote node associated with the adjacency SID and a node ID TLV comprising the identifier of the node.

17. The method of claim 9, wherein the identifier comprises an Open Shortest Path First (OSPF) node identifier, an Intermediate System to Intermediate System (IS-IS) node identifier, or a BGP node identifier.

18. A non-neighbor upstream endpoint node configured to enable traffic to continue to be forwarded on a Segment Routing Traffic Engineering (SR-TE) path after a failure of a node along the SR-TE path, the non-neighbor upstream endpoint node comprising:
a memory storing instructions; and
one or more processors coupled to the memory and configured to execute the instructions to cause the non-neighbor upstream endpoint node to:
receive a packet, wherein the packet comprises a list of segment identifiers (SIDs) of the SR-TE path that includes a first node SID of the non-neighbor upstream endpoint node and a second node SID of the node;
determine that the second node SID is a failed node SID of the node;
remove, in response to determining that the second node SID is the failed node SID of the node, the first node SID and the second node SID from the packet; and
send the packet to a next hop node on an interior gateway protocol (IGP) shortest path to a destination node.

19. The non-neighbor upstream endpoint node of claim 18, wherein the one or more processors are further configured to execute the instructions to cause the non-neighbor upstream endpoint node to send the packet towards a node Nx along the IGP shortest path to the node Nx when a top SID of the packet is a node SID of the node Nx.

20. The non-neighbor upstream endpoint node of claim 18, wherein when a top SID is an adjacency SID of the node, the one or more processors are further configured to execute the instructions to cause the non-neighbor upstream endpoint node to:
obtain a remote node associated with the adjacency SID;
replace the adjacency SID with a node SID of the remote node; and
send the packet towards the remote node along the IGP shortest path to the remote node.
